(19) United States
(12) Patent Application Publication
(10) Pub. No.: US 2006/0152503 A1
(43) Pub. Date: Jul. 13, 2006

(54) Method and apparatus for transforming two-dimensional building data to three-dimensional building data in real time and method and apparatus for three-dimensionally visualizing two-dimensional building data in real time

(75) Inventors: Keechang Lee, Yongin-si (KR); Dokyoon Kim, Seongnam-si (KR); Jeonghwan Ahn, Suwon-si (KR); Shinjun Lee, Seoul (KR); Heesae Lee, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/185,858

(22) Filed: Jul. 21, 2005

(30) Foreign Application Priority Data
Jan. 7, 2005 (KR) 10-2005-0001539

(51) Int. Cl. G06T 15/00

(52) U.S. Cl. 345/419; 345/582

(57) ABSTRACT

A method of and apparatus for transforming two-dimensional building data to three-dimensional building data in real time and a method and apparatus for three-dimensionally visualizing two-dimensional building data in real time. The method of transforming two-dimensional building data to three-dimensional building data in real time includes: determining a relative distance between a building and a reference point; selecting a visualization scheme for the building according to the determined relative distance; and generating the three-dimensional building data using building story information based on the selected visualization scheme. Accordingly, the buildings are depicted with different visualization schemes according to a relative distance between each of the buildings and a reference point, so that reality of the three-dimensional visualization can be improved and intuitive perception and convenience can be provided to a user.

### CROSS-REFERENCE TO RELATED APPLICATION

This application claims the benefit of Korean Patent Application No. 2005-0001539, filed on Jan. 7, 2005, in the Korean Intellectual Property Office, the disclosure of which is incorporated herein by reference.

### BACKGROUND OF THE INVENTION

1. Field of the Invention

The present invention relates to car navigation, and more particularly, to a method and apparatus for transforming two-dimensional building data to three-dimensional building data in real time and a method and apparatus for three-dimensionally visualizing two-dimensional building data in real time.

2. Description of Related Art

Recently, the increase in the number of cars on roads has caused a serious problem of traffic congestion. In order to solve the traffic congestion, there have been developed car navigation systems such as a global positioning system (GPS). A car navigation system has basic functions of tracking a position of a car and displaying the position on a road map. The car navigation system has additional functions of monitoring traffic situation of roads and providing the traffic situation information to drivers.

A well-visualized car navigation system enables drivers to accurately locate their destination on the road map. In addition, when a car runs at a high speed, a three-dimensionally visualized road map of the car navigation system provides more convenience and safety to a driver than a two-dimensional map provides. Buildings and geographical features are depicted three-dimensionally on the three-dimensionally visualized road map, so that the driver can perceive them intuitively.

Conventional car navigation systems store two-dimensional data and visualize the data two-dimensionally. In some of the conventional car navigation systems, numerals corresponding to the number of stories of buildings are written on the buildings displayed on the road map. These conventional car navigation systems cannot provide intuitive perception on heights of the buildings to the drivers.

### BRIEF SUMMARY

An aspect of the present invention provides a method and apparatus for transforming two-dimensional building data to three-dimensional building data in real time and a computer-readable medium having embodied thereon a computer program for the method.

An aspect of the present invention provides a method and apparatus for three-dimensionally visualizing two-dimensional building data in real time and a computer-readable medium having embodied thereon a computer program for the method.

According to an aspect of the present invention, there is provided a method of transforming two-dimensional building data to three-dimensional building data in real time, including: determining a relative distance between a building and a reference point; selecting a visualization scheme for the building according to the determined relative distance; and generating the three-dimensional building data using building story information based on the selected visualization scheme.

According to another aspect of the present invention, there is provided an apparatus for transforming two-dimensional building data to three-dimensional building data in real time, including: a distance determination unit determining a relative distance between a building and a reference point; an appearance selection unit selecting a visualization scheme for the building according to the determined relative distance; and a three-dimensional data generation unit generating the three-dimensional building data using building story information based on the selected visualization scheme.

According to still another aspect of the present invention, there is provided a method of three-dimensionally visualizing two-dimensional building data in real time, including: determining a relative distance between a building and a reference point; selecting a visualization scheme for the building according to the determined relative distance; generating the three-dimensional building data using building story information based on the selected visualization scheme; and visualizing the three-dimensional building data according to the selected visualization scheme.

According to yet another aspect of the present invention, there is provided an apparatus for three-dimensionally visualizing two-dimensional building data in real time, including: a distance determination unit determining a relative distance between a building and a reference point; an appearance selection unit selecting a visualization scheme for the building according to the determined relative distance; a three-dimensional data generation unit generating the three-dimensional building data using building story information based on the selected visualization scheme; and a building visualization unit visualizing the three-dimensional building data according to the selected visualization scheme.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram showing a construction of a navigation system according to an embodiment of the present invention;

FIG. 2 is a view showing visualization schemes selected according to a relative distance between a building and a reference point according to an embodiment of the present invention;

FIG. 3 is a view showing an example of a triangle strip structure of side surface data;

FIG. 4 is a view showing triangles in a format of a triangle fan according to an embodiment of the present invention if a two-dimensional shape of the building is a convex polygon;

FIG. 5 is a view showing triangles segmented if a two-dimensional shape of the building is a concave polygon;

FIG. 6 is a view showing a color determination scheme for forming shading by using a source vector according to an embodiment of the present invention;

FIG. 7 is a view showing another color determination scheme where colors are designated to side surfaces according to a listing order of the side surfaces in side surface data; and

FIGS. 8A to 8C are views showing a visualization scheme for a texture applying unit where a repetition number of texture is determined and a texture array is applied on an outside wall of a building according to an embodiment of the present invention.

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

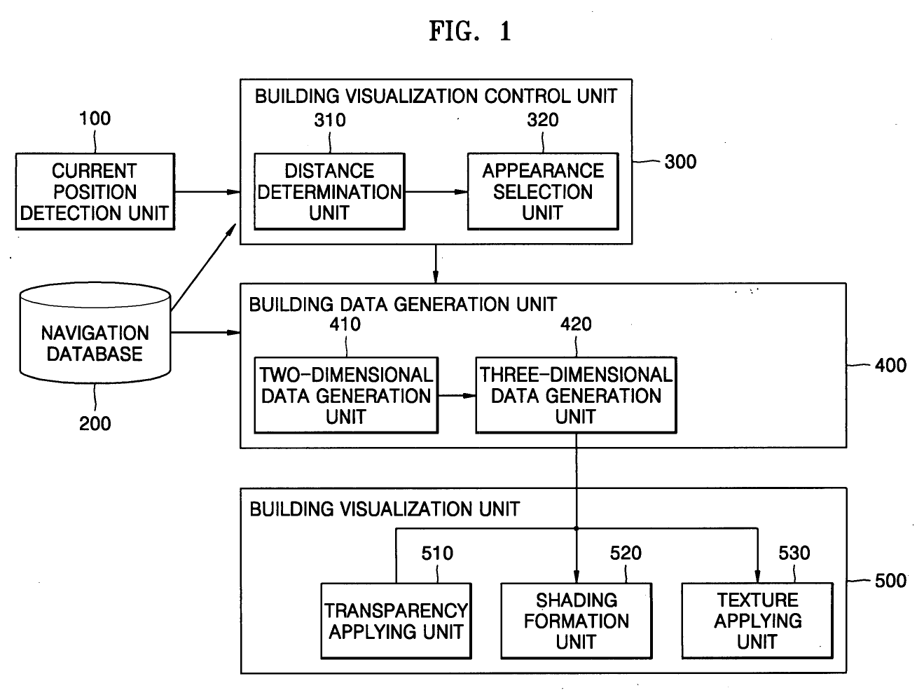

FIG. 1 is a block diagram showing a construction of a navigation system according to an embodiment of the present invention.

The navigation system includes a current position detection unit 100, navigation database 200, a building visualization control unit 300, a building data generation unit 400, and a building visualization unit 500.

The current position detection unit 100 detects a current position of a vehicle by using the navigation system such as a global position system (GPS).

The navigation database 200 stores data which is displayed on a screen of the navigation system.

The building visualization control unit 300 transforms two-dimensional building data to a three-dimensional building data and controls visualization information. In an embodiment of the present invention, the building visualization control unit 300 includes a distance determination unit 310 and an appearance selection unit 320.

The distance determination unit 310 determines a relative distance between a building and a reference point. The reference point may be a user's position or a position of a camera. The user's position is the position of the vehicle detected with the aforementioned current position detection unit 100. The user can find navigation information by changing the position of the camera in the navigation system without change of the user's position.

The appearance selection unit 320 selects a visualization scheme for the building according to the relative distance between the building and the reference point determined by the distance determination unit 310. The visualization scheme includes one of a first building visualization scheme where only a bottom surface of the building is depicted, a second building visualization scheme where the building is depicted semi-transparently or transparently, a third building visualization scheme where the building is depicted with shading, a fourth building visualization scheme where a texture array is applied on an outside wall of the building, and a fifth building visualization scheme where the building is not depicted.

In the present embodiment, as the relative distance between the building and the reference point increases, the visualization scheme changes, so that reality of the three-dimensional visualization can be improved and intuitive perception and convenience can be provided to the user.

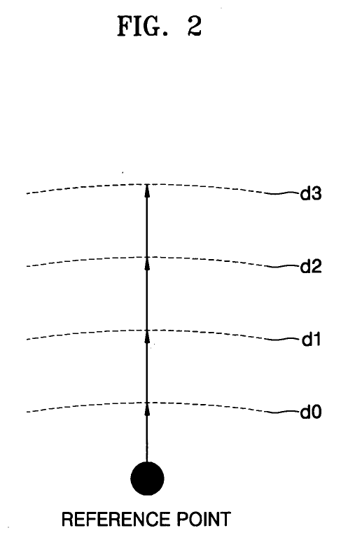

FIG. 2 is a view showing visualization schemes selected according to a relative distance between a building and a reference point according to an embodiment of the present invention.

In the embodiment shown in FIG. 2, distance d0, d1, d2, and d3 are positive real numbers having a relation: d0<d1<d2<d3. In a case where a building is at the nearest position (the relative distance is shorter than d0), the preferred visualization scheme is the first building visualization scheme where only a bottom surface of the building is depicted. If the nearest building is visualized with height, buildings and geographical features behind the nearest building cannot be shown.

In a case where a building is at a near position (the relative distance is equal to or larger than the distance d0 and shorter than the distance d1), the preferred visualization scheme is the second building visualization scheme where the building is depicted semi-transparently or transparently. Since the near building is visualized semi-transparently or transparently, buildings and geographical features behind the near building can be shown.

In a case where a building is at a far position (the relative distance is equal to or larger than the distance d1 and shorter than the distance d2; or the relative distance is equal to or larger than the distance d2 and shorter than the distance d3), the preferred visualization scheme is the third building visualization scheme where the building is depicted with shading or the fourth building visualization scheme where a texture array is applied on an outside wall of the building. By the third or fourth building visualizations scheme, the building can be shown more realistically. In an example, if the relative distance is equal to or larger than the distance d1 and shorter than the distance d2, the building is depicted with shading; and if the relative distance is equal to or larger than the distance d2 and shorter than the distance d3, a texture array is applied on an outside wall of the building. In another example, if the relative distance is equal to or larger than the distance d1 and shorter than the distance d2, a texture array is applied on an outside wall of the building; and if the relative distance is equal to or larger than the distance d2 and shorter than the distance d3, the building is depicted with shading.

In a case where a building is at the farthermost position (the relative distance is equal to or larger than the distance d3), the preferred visualization scheme is the fifth building visualization scheme where the building is not depicted. In most cases, information on the farthermost buildings need not be provided. In addition, the farthermost buildings shielded with near buildings need not be depicted.

While various preferred visualizations schemes have been described in the foregoing paragraphs, it is to be understood that these schemes are intended merely as non-limiting examples. Indeed, other schemes, distances, and relationships between distances and schemes are both possible and contemplated.

Returning to FIG. 1, the building data generation unit 400 generates navigation data to be provided to the user by using the data stored in the navigation database 200. In the embodiment showing in FIG. 1, the building data generation unit 400 includes a two-dimensional data generation unit 410 and a three-dimensional data generation unit 420.

The two-dimensional data generation unit 410 generates two-dimensional data by using the data stored in the navigation database 200. For example, the building data generation unit 400 may not include the two-dimensional data generation unit 410, and the two-dimensional building data may be stored in the navigation database 200. For example, the two-dimensional building data is directly transmitted to the three-dimensional data generation unit 420.

The three-dimensional data generation unit 420 transforms the two-dimensional building data to the three-dimensional building data by using building story information based on the visualization scheme selected by the appearance selection unit 320.

The three-dimensional data generation unit 420 may include a bottom height coordinate addition unit (not shown). The bottom height coordinate addition unit generates three-dimensional data by adding a height coordinate of 0 to the two-dimensional data in the first building visualization scheme where only a bottom surface of the building is depicted.

The three-dimensional data generation unit 420 may include the top surface data generation unit (not shown), a bottom surface data generation unit (not shown), and a side surface data generation unit (not shown). These components are used to completely depict the building in the aforementioned second to fourth building visualization schemes.

The top surface data generation unit generates three-dimensional top surface data corresponding to a top surface of the building. In an example, the top surface data generation unit may calculate a product of a number of stories of the building and a height transformation constant and add the product (a height coordinate) to the two-dimensional data.

The bottom surface data generation unit generates three-dimensional bottom surface data corresponding to a bottom surface of the building. In an example, the bottom surface data generation unit adds a height coordinate of 0 to the two-dimensional data.

The side surface data generation unit generates three-dimensional side surface data corresponding to a side surface of the building. In an example, the three-dimensional side surface data generated by the side surface data generation unit has a triangle strip structure where vertexes on the top surface and vertexes on the bottom surface are alternately arranged.

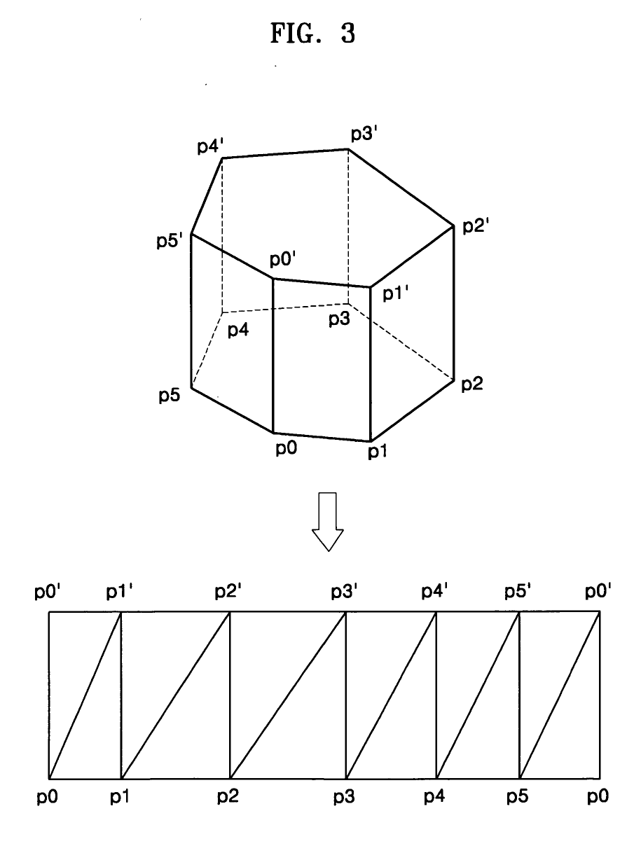

FIG. 3 is a view showing an example of a triangle strip structure of side surface data. The top surface of the building contains vertexes p0′, p1′, p2′, p3′, p4′, and p5′; and the bottom surface of the building contains vertexes p0, p1, p2, p3, p4, and p5. The side surface contains vertexes p0′, p0, p1′, p1, p2′, p2, p3′, p3, p4′, p4, p5′, p5, p0′, and p0.

In the triangle strip structure, a triangle is initially represented by arraying three vertexes, and a new triangle is generated by adding a new vertex to the previously arrayed vertexes. In an example shown in FIG. 3, a triangle is initially represented by arraying vertexes p0′, p0, and p1′, and then, a new vertex p1 is added to the previous vertexes p0 and p1′ to generate a new triangle including three vertexes p0, p1′, and p1.

In the present embodiment, the side surface data generation unit generates the side surface by using the triangle strip structure. As shown in a lower view of FIG. 3, the vertexes of the top and bottom surfaces of the building are alternately arrayed to generate the triangle strip.

The triangle strip expression scheme of FIG. 3 can be represented by using Algorithm 1 in a rendering language.

[Algorithm 1]

RenderingType(TRIANGLE_STRIP)

Vertex3D(p0′); Vertex3D(p0);

Vertex3D(p1′); Vertex3D(p1);

Vertex3D(p2′); Vertex3D(p2);

Vertex3D(p3′); Vertex3D(p3);

Vertex3D(p4′); Vertex3D(p4);

Vertex3D(p5′); Vertex3D(p5);

Vertex3D(p0′); Vertex3D(p0);

End (TRIANGLE_STRIP)

Referring to Algorithm 1, it can be seen that in the triangle strip expression scheme, a newly added triangle (a newly added vertex) is obtained by adding one vertex as described above. Therefore, the number of transmitted information of the vertexes can decrease, and the triangle strip structure can be accelerated by hardware, so that the rendering speed can increase greatly.

The three-dimensional data generation unit 420 stores the input building data in the most efficient data format according to the characteristics of the polygon of the top and bottom surfaces of the building.

The input building data corresponds to a triangle, the triangle is stored as it is. In a case where the input building data corresponds to a polygon, the polygon is segmented into a plurality of triangles. At this time, the polygons are classified into convex and concave polygons.

The three-dimensional data generation unit 420 may include a triangle fan transformation unit. The triangle fan transformation unit transforms the three-dimensional data of top and bottom surfaces of the building in a format of a triangle fan if a two-dimensional shape of the building is a convex polygon.

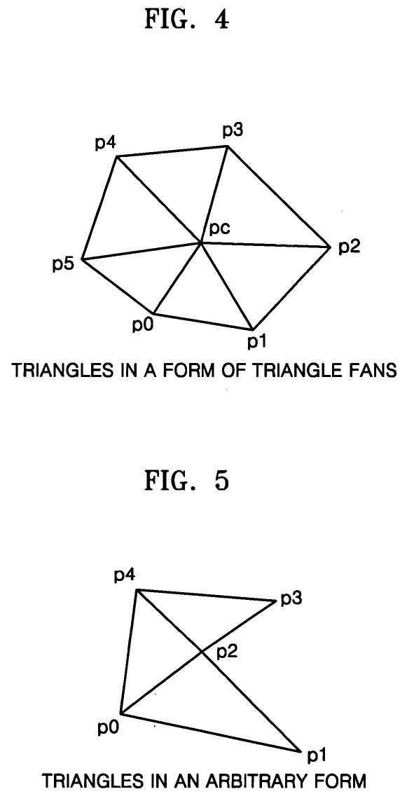

FIG. 4 is a view showing triangles in a format of a triangle fan according to an embodiment of the present invention. The input data is a convex polygon including the vertexes p0, p1, p2, p3, p4, and p5. An arbitrary point pc existing within the convex polygon is selected. In the most cases, pc is the center of polygon. The convex polygon can be segmented into triangles constructed with the sides of the convex polygon and the point pc. As shown in FIG. 4, triangle fans around the point pc are obtained.

The triangle fan expression scheme of FIG. 4 can be represented by using Algorithm 2 in a rendering language.

[Algorithm 2]

RenderingType(TRIANGLE_FAN)

Vertex3D(pc);

Vertex3D(p0);

Vertex3D(p1);

Vertex3D(p2);

Vertex3D(p3);

Vertex3D(p4);

Vertex3D(p5);

End(TRIANGLE_FAN)

By using the triangle fan expression scheme, the number of the to-be-transmitted vertexes can decrease, and the rendering speed can increase greatly with hardware supporting the triangle fan expression scheme.

The three-dimensional data generation unit 420 may include a concave polygon segmentation unit (not shown). If the two-dimensional shape of the building is the concave polygon, the concave polygon segmentation unit segments the three-dimensional data of the top and bottom surfaces of the building into at least one triangle. The input building data is stored in units of the segmented triangles.

FIG. 5 is a view showing triangles segmented if a two-dimensional shape of the building is a concave polygon. In the example, the concave polygon having five vertexes p0, p1, p2, 3p, and p4 is segmented into three triangles having respective three vertexes (p0, p1, p2), (p0, p2, p4), and (p2, p3, p4).

The expression scheme of FIG. 5 can be represented by using Algorithm 3 in a rendering language.

[Algorithm 3]

RenderingType(TRIANGLE)

Vertex3D(p0);

Vertex3D(p1);

Vertex3D(p2);

Vertex3D(p0);

Vertex3D(p2);

Vertex3D(p4);

Vertex3D(p2);

Vertex3D(p3);

Vertex3D(p4);

End(TRIANGLE)

Returning to FIG. 1, the building visualization unit 500 visualizes the three-dimensional building data on a screen according to a visualization scheme selected by the appearance selection unit 320. Preferably, the building visualization unit 500 includes a transparency applying unit 510, a shading formation unit 520, and a texture applying unit 530.

The transparency applying unit 510 applies transparency or semi-transparency to surfaces of the building, so that buildings and geographical features behind the nearest building can be depicted.

The shading formation unit 520 uses a visualization scheme where the building is depicted with shading, to form shading by designating different color brightness to different side surfaces of the building.

The shading formation unit 520 may include a light source setting unit (not shown), an angle calculation unit (not shown), and a color determination unit (not shown). The light source setting unit sets a light source vector. The angle calculation unit calculates angles between the light source vector and side surfaces of the building. The color determination unit determines colors of the side surfaces according to the respective angles.

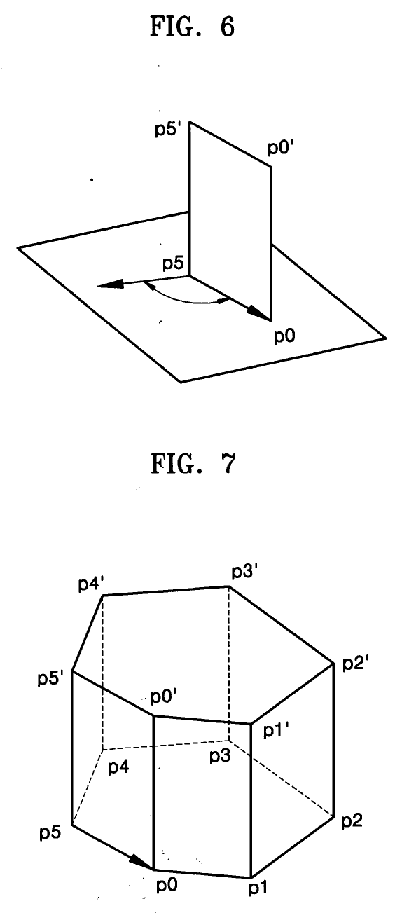

FIG. 6 is a view showing a color determination scheme for forming shading by using a source vector according to an embodiment of the present invention. In the color determination scheme, as the angle between the source vector and a side surface goes to 90°, the color brightness increases. On the contrary, as the angle between the source vector and the side surface goes to 0°, the source illuminates the side surface in a slanted angle, so that the color brightness decreases. The color of side surface can be determined based on a product of the number of available colors and the angle between the source vector and the side surface. For example, a bright color (a high order color) is designated to a side surface corresponding to a large angle, and a dark color (a low order color) is designated to a side surface corresponding to a small angle.

The shading formation unit 520 may designate gradually-changing colors to the respective side surfaces of the building according to a listing order of the side surfaces in side surface data. FIG. 7 is a view showing a color determination scheme where colors are designated to side surfaces according to a listing order of the side surfaces in side surface data. Unlike the embodiment of FIG. 6, the brightness of the colors designated to respective side surfaces changes gradually to depict shading of the building according to the listing order of the side surface of the building

In a visualization scheme where a texture array is applied on an outside wall of the building, the texture applying unit 530 defines horizontal and vertical repetition numbers of textures in the texture array to be applied on the outside wall.

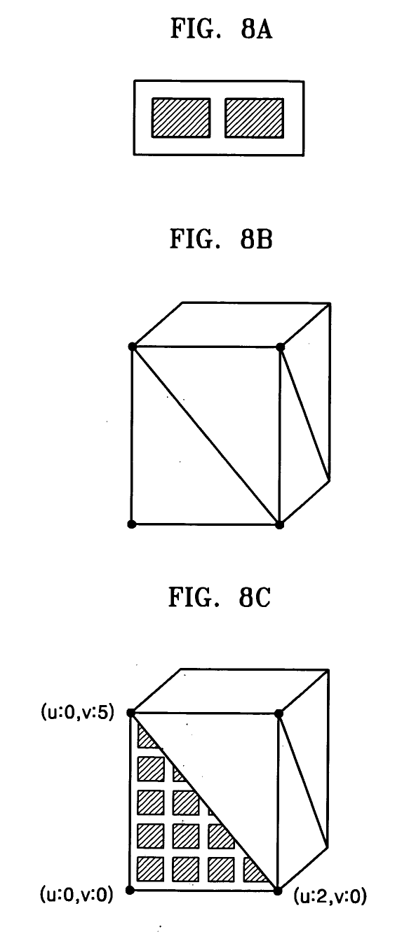

FIGS. 8A to 8C are views showing the visualization scheme for a texture applying unit where a repetition number of texture is determined and a texture array is applied on an outside wall of a building according to an embodiment of the present invention. FIG. 8A shows an example of the texture. FIG. 8B shows the building to which the texture is to be applied. FIG. 8C shows the building of FIG. 8B to which the texture of FIG. 9A is repeatedly applied.

Before the textures are applied, the repetition number of textures which are to be applied to a sidewall has to be determined. In an embodiment of the present invention, a horizontal length (u-factor) of the outside wall divided by a predetermined horizontal-length coefficient is defined as the horizontal repetition number of the textures. In addition, in an embodiment of the present invention, the number of stories of the building is defined as the vertical repetition number of the textures. In an example shown in FIG. 8C, the horizontal and vertical repetition numbers of the textures are 2 and 5, respectively.

According to the above-described embodiments, in a method and apparatus for transforming two-dimensional building data to three-dimensional building data in real time and a method and apparatus for three-dimensionally visualizing two-dimensional building data in real time, a navigation system depicts buildings with different visualization schemes according to a relative distance between each of the building and a reference point, so that reality of the three-dimensional visualization can be improved and intuitive perception and convenience can be provided to a user. In addition, according to an embodiment of the present invention, a rendering speed can be increased by using a triangle strip or fan expression scheme supported by hardware.

Embodiments of the present invention can also be embodied as computer-readable codes on a computer-readable recording medium. The computer-readable recording medium is any data storage device that can store data which can be thereafter read by a computer system. Examples of the computer-readable recording media include read-only memory (ROM), random-access memory (RAM), CD-ROMs, magnetic tapes, floppy disks, and optical data storage devices.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of transforming two-dimensional building data to three-dimensional building data in real time, comprising:
determining a relative distance between a building and a reference point;
selecting a visualization scheme for the building according to the determined relative distance; and
generating the three-dimensional building data using building story information based on the selected visualization scheme.

2. The method according to claim 1, wherein the reference point is a user's position.

3. The method according to claim 1, wherein the reference point is a position of a camera.

4. The method according to claim 1, wherein the selecting includes:
selecting a first building visualization scheme where only a bottom surface of the building is depicted when the relative distance is shorter than a distance d0, distance d0 being a positive real number;
selecting a second building visualization scheme where the building is depicted semi-transparently or transparently when the relative distance is equal to or larger than the distance d0 and shorter than a distance d1, distance d1 being larger than d0;
selecting a third building visualization scheme where the building is depicted with shading when the relative distance is equal to or larger than the distance d1 and shorter than a distance d2, distance d2 being larger than d1;
selecting a fourth building visualization scheme where a texture array is applied on an outside wall of the building when the relative distance is equal to or larger than the distance d2 and shorter than a distance d3, distance d3 being larger than d2; and
selecting a fifth building visualization scheme where the building is not depicted when the relative distance is equal to or larger than the distance d3.

5. The method according to claim 1, wherein the generating includes generating three-dimensional data by adding a height coordinate of 0 to the two-dimensional data when the building visualization scheme is a scheme where only a bottom surface of the building is depicted.

6. The method according to claim 1, wherein the generating includes:
generating three-dimensional top surface data corresponding to a top surface of the building;
generating three-dimensional bottom surface data corresponding to a bottom surface of the building; and
generating three-dimensional side surface data corresponding to a side surface of the building.

7. The method according to claim 6, wherein the generating three-dimensional top surface data includes generating the three-dimensional top surface data of the building by adding a height coordinate to the two-dimensional data, where the height coordinate is a product of a number of stories of the building and a height transformation constant.

8. The method according to claim 6, wherein the generating three-dimensional bottom surface data includes generating three-dimensional bottom surface data of the building by adding a height coordinate of 0 to the two-dimensional data.

9. The method according to claim 6, wherein the generating three-dimensional side surface data includes generating the three-dimensional side surface data of the building, wherein the side surface data has a triangle strip structure where vertexes on the top surface and vertexes on the bottom surface are alternately arranged.

10. The method according to claim 6, wherein the generating includes transforming the three-dimensional top surface data and the three-dimensional bottom surface in a format of a triangle fan when a two-dimensional shape of the building is a convex polygon.

11. The method according to claim 6, wherein the generating includes transforming the three-dimensional top surface data and the three-dimensional bottom surface in a format of at least one segmented triangles when a two-dimensional shape of the building is a concave polygon.

12. An apparatus for transforming two-dimensional building data to three-dimensional building data in real time, comprising:
a distance determination unit determining a relative distance between a building and a reference point;
an appearance selection unit selecting a visualization scheme for the building according to the determined relative distance; and
a three-dimensional data generation unit generating the three-dimensional building data using building story information based on the selected visualization scheme.

13. The apparatus according to claim 12, wherein the reference point is a user's position.

14. The apparatus according to claim 12, wherein the reference point is a position of a camera.

15. The apparatus according to claim 12, wherein the appearance selection unit comprises:
a first building visualization scheme selection unit selecting a first building visualization scheme where only a bottom surface of the building is depicted when the relative distance is shorter than a distance d0, distance d0 being a positive real number;
a second building visualization scheme selection unit selecting a second building visualization scheme where the building is depicted semi-transparently or transparently when the relative distance is equal to or larger than the distance d0 and shorter than a distance d1, distance d1 being larger than d0;
a third building visualization scheme selection unit selecting a third building visualization scheme where the building is depicted with shading when the relative distance is equal to or larger than the distance d1 and shorter than a distance d2, distance d2 being larger than d1;
a fourth building visualization scheme selection unit selecting a fourth building visualization scheme where a texture array is applied on an outside wall of the building when the relative distance is equal to or larger than the distance d2 and shorter than a distance d3, distance d3 being larger than d2; and
a fifth building visualization scheme selection unit selecting a fifth building visualization scheme where the building is not depicted when the relative distance is equal to or larger than the distance d3.

16. The apparatus according to claim 12, wherein the three-dimensional data generation unit includes a bottom height coordinate addition unit generating three-dimensional data by adding a height coordinate of 0 to the two-dimensional data when the building visualization scheme is a scheme where only a bottom surface of the building is depicted.

17. The apparatus according to claim 12, wherein the three-dimensional data generation unit includes:
a top surface data generation unit generating three-dimensional top surface data corresponding to a top surface of the building;
a bottom surface data generation unit generating three-dimensional bottom surface data corresponding to a bottom surface of the building; and
a side surface data generation unit generating three-dimensional side surface data corresponding to a side surface of the building.

18. The apparatus according to claim 17, wherein the top surface data generation unit includes a height coordinate addition unit generating the three-dimensional top surface data of the building by adding a height coordinate to the two-dimensional data, where the height coordinate is a product of a number of stories of the building and a height transformation constant.

19. The apparatus according to claim 17, wherein the bottom surface data generation unit includes a bottom height coordinate addition unit generating three-dimensional bottom surface data of the building by adding a height coordinate of 0 to the two-dimensional data.

20. The apparatus according to claim 17, wherein the side surface data generation unit includes a triangle strip structure generation unit generating the three-dimensional side surface data of the building, wherein the side surface data has a triangle strip structure where vertexes on the top surface and vertexes on the bottom surface are alternately arranged.

21. The apparatus according to claim 17, wherein the three-dimensional data generation unit includes a triangle fan transformation unit transforming the three-dimensional top surface data and the three-dimensional bottom surface in a format of a triangle fan when a two-dimensional shape of the building is a convex polygon.

22. The apparatus according to claim 17, wherein the three-dimensional data generation unit includes a concave polygon segmentation unit transforming the three-dimensional top surface data and the three-dimensional bottom surface in a format of at least one segmented triangles when a two-dimensional shape of the building is a concave polygon.

23. A method of three-dimensionally visualizing two-dimensional building data in real time, comprising:
determining a relative distance between a building and a reference point;
selecting a visualization scheme for the building according to the determined relative distance;
generating the three-dimensional building data using building story information based on the selected visualization scheme; and
visualizing the three-dimensional building data according to the selected visualization scheme.

24. The method according to claim 23, wherein the reference point is a user's position.

25. The method according to claim 23, wherein the reference point is a position of a camera.

26. The method according to claim 23, wherein the selecting includes:
selecting a first building visualization scheme where only a bottom surface of the building is depicted when the relative distance is shorter than a distance d0, distance d0 being a positive real number;
selecting a second building visualization scheme where the building is depicted semi-transparently or transparently when the relative distance is equal to or larger than the distance d0 and shorter than a distance d1, distance d1 being larger than d0;
selecting a third building visualization scheme where the building is depicted with shading when the relative distance is equal to or larger than the distance d1 and shorter than a distance d2, distance d2 being larger than d1;
selecting a fourth building visualization scheme where a texture array is applied on an outside wall of the building when the relative distance is equal to or larger than the distance d2 and shorter than a distance d3, distance d3 being larger than d2; and
selecting a fifth building visualization scheme where the building is not depicted when the relative distance is equal to or larger than the distance d3.

27. The method according to claim 23, wherein the generating includes generating three-dimensional data by adding a height coordinate of 0 to the two-dimensional data when the building visualization scheme is a scheme where only a bottom surface of the building is depicted.

28. The method according to claim 23, wherein the generating includes:
generating three-dimensional top surface data corresponding to a top surface of the building;
generating three-dimensional bottom surface data corresponding to a bottom surface of the building; and
generating three-dimensional side surface data corresponding to a side surface of the building.

29. The method according to claim 28, wherein the generating three-dimensional top surface data includes generating the three-dimensional top surface data of the building by adding a height coordinate to the two-dimensional data, where the height coordinate is a product of a number of stories of the building and a height transformation constant.

30. The method according to claim 28, wherein the generating three-dimensional bottom surface data includes generating three-dimensional bottom surface data of the building by adding a height coordinate of 0 to the two-dimensional data.

31. The method according to claim 28, wherein the generating three-dimensional side surface data generating the three-dimensional side surface data of the building, wherein the side surface data has a triangle strip structure where vertexes on the top surface and vertexes on the bottom surface are alternately arranged.

32. The method according to claim 28, wherein the generating includes transforming the three-dimensional top surface data and the three-dimensional bottom surface in a format of a triangle fan when a two-dimensional shape of the building is a convex polygon.

33. The method according to claim 28, wherein the generating includes transforming the three-dimensional top surface data and the three-dimensional bottom surface in a format of at least one segmented triangles when a two-dimensional shape of the building is a concave polygon.

34. The method according to claim 23, wherein the visualization scheme is a scheme in which the building is depicted with shading, and
wherein the visualizing includes forming shading by designating different brightness to colors of different side surfaces of the building.

35. The method according to claim 34, wherein the forming shading includes:
setting a light source vector;
calculating angles between the light source vector and side surfaces of the building; and
determining colors of the side surfaces according to the respective angles.

36. The method according to claim 34, wherein the forming shading includes designating colors to the side surfaces according to a listing order of the side surfaces in side surface data.

37. The method according to claim 23, wherein the visualization scheme is a scheme in which a texture array is applied on an outside wall of the building, and
wherein the visualizing includes defining horizontal and vertical repetition numbers of textures in the texture array to be applied on the outside wall.

38. The method according to claim 37, wherein the defining horizontal and vertical repetition numbers includes defining as the repetition number of the textures included in the horizontal axis a horizontal length of the outside wall divided by a predetermined horizontal-length coefficient.

39. The method according to claim 37, wherein the defining horizontal and vertical repetition numbers includes defining as the number of the textures included in the vertical axis the number of stories of the building.

40. An apparatus for three-dimensionally visualizing two-dimensional building data in real time, comprising:
a distance determination unit determining a relative distance between a building and a reference point;
an appearance selection unit selecting a visualization scheme for the building according to the determined relative distance;
a three-dimensional data generation unit generating the three-dimensional building data using building story information based on the selected visualization scheme; and
a building visualization unit visualizing the three-dimensional building data according to the selected visualization scheme.

41. The apparatus according to claim 40, wherein the reference point is a user's position.

42. The apparatus according to claim 40, wherein the reference point is a position of a camera.

43. The apparatus according to claim 40, wherein the appearance selection unit comprises:
a first building visualization scheme selection unit selecting a first building visualization scheme where only a bottom surface of the building is depicted when the relative distance is shorter than a distance d0, distance d0 being a positive real number;
a second building visualization scheme selection unit selecting a second building visualization scheme where the building is depicted semi-transparently or transparently when the relative distance is equal to or larger than the distance d0 and shorter than a distance d1, distance d1 being larger than d0;
a third building visualization scheme selection unit selecting a third building visualization scheme where the building is depicted with shading when the relative distance is equal to or larger than the distance d1 and shorter than a distance d2, distance d2 being larger than d1;
a fourth building visualization scheme selection unit selecting a fourth building visualization scheme where a texture array is applied on an outside wall of the building when the relative distance is equal to or larger than the distance d2 and shorter than a distance d3, distance d3 being larger than d2; and
a fifth building visualization scheme selection unit selecting a fifth building visualization scheme where the building is not depicted when the relative distance is equal to or larger than the distance d3.

44. The apparatus according to claim 40, wherein the three-dimensional data generation unit includes a bottom height coordinate addition unit generating three-dimensional data by adding a height coordinate of 0 to the two-dimensional data if the building visualization scheme is a scheme where only a bottom surface of the building is depicted.

45. The apparatus according to claim 40, wherein the three-dimensional data generation unit includes:
a top surface data generation unit generating three-dimensional top surface data corresponding to a top surface of the building;
a bottom surface data generation unit generating three-dimensional bottom surface data corresponding to a bottom surface of the building; and
a side surface data generation unit generating three-dimensional side surface data corresponding to a side surface of the building.

46. The apparatus according to claim 45, wherein the top surface data generation unit includes a height coordinate addition unit generating the three-dimensional top surface data of the building by adding a height coordinate to the two-dimensional data, where the height coordinate is a product of a number of stories of the building and a height transformation constant.

47. The apparatus according to claim 45, wherein the bottom surface data generation unit includes a bottom height coordinate addition unit generating three-dimensional bottom surface data of the building by adding a height coordinate of 0 to the two-dimensional data.

48. The apparatus according to claim 45, wherein the side surface data generation unit includes a triangle strip structure generation unit generating the three-dimensional side surface data of the building, wherein the side surface data has a triangle strip structure where vertexes on the top surface and vertexes on the bottom surface are alternately arranged.

49. The apparatus according to claim 45, wherein the three-dimensional data generation unit includes a triangle fan transformation unit transforming the three-dimensional top surface data and the three-dimensional bottom surface in a format of a triangle fan when a two-dimensional shape of the building is a convex polygon.

50. The apparatus according to claim 45, wherein the three-dimensional data generation unit includes transforming the three-dimensional top surface data and the three-dimensional bottom surface in a format of at least one segmented triangles when a two-dimensional shape of the building is a concave polygon.

51. The apparatus according to claim 40, wherein the visualization scheme is a scheme in which the building is depicted with shading, and
wherein the building visualization unit includes a shading formation unit forming shading by designating different brightness to colors of different side surfaces of the building.

52. The apparatus according to claim 51, wherein the shading formation unit includes:
a light source setting unit setting a light source vector;
an angle calculation unit calculating angles between the light source vector and side surfaces of the building; and
a color determination unit determining colors of the side surfaces according to the respective angles.

53. The apparatus according to claim 51, wherein the shading formation unit includes a color designation unit designating colors to the side surfaces according to a listing order of the side surfaces in side surface data.

54. The apparatus according to claim 40, wherein the visualization scheme is a scheme in which a texture array is applied on an outside wall of the building, and
wherein the building visualization unit includes a texture applying unit determining horizontal and vertical repetition numbers of textures in the texture array to be applied on the outside wall.

55. The apparatus according to claim 54, wherein texture applying unit includes a horizontal-number-of-texture definition unit defining as the repetition number of the textures included in the horizontal axis a horizontal length of the outside wall divided by a predetermined horizontal-length coefficient.

56. The apparatus according to claim 54, wherein the texture applying unit includes a vertical-number-of-texture definition unit defining as the repetition number of the textures included in the vertical axis the number of stories of the building.

57. A computer-readable medium having embodied thereon a computer program for a method of transforming two-dimensional building data to three-dimensional building data in real time, the method comprising:
determining a relative distance between a building and a reference point;
selecting a visualization scheme for the building according to the determined relative distance; and generating the three-dimensional building data using building story information based on the selected visualization scheme.

58. A computer-readable medium having embodied thereon a computer program for a method of three-dimensionally visualizing two-dimensional building data in real time, the method comprising:
determining a relative distance between a building and a reference point;
selecting a visualization scheme for the building according to the determined relative distance; and
generating the three-dimensional building data using building story information based on the selected visualization scheme; and
visualizing the three-dimensional building data on a screen according to the selected visualization scheme.
